(19) United States
(12) Patent Application Publication
(10) Pub. No.: US 2025/0389288 A1
(43) Pub. Date: Dec. 25, 2025

(54) METHOD FOR THE OPERATION OF A PNEUMATIC SYSTEM AND PNEUMATIC SYSTEM

(71) Applicant: Festo SE & Co. KG, Esslingen (DE)

(72) Inventors: Martin KLOSOK, Waiblingen (DE); Gabriel DÄMMER, Esslingen (DE); Gerold RALL, Dunningen (DE)

(21) Appl. No.: 19/242,010

(22) Filed: Jun. 18, 2025

(30) Foreign Application Priority Data
Jun. 20, 2024 (DE) 10 2024 117 373.4

(51) Int. Cl. F15B 21/08; F15B 20/00; F15B 21/02

(52) U.S. Cl. CPC F15B 21/082; F15B 20/00; F15B 21/02

(57) ABSTRACT

A method including a pneumatic function component which includes a valve apparatus and at least one pneumatic actuator which can be pneumatically actuated by way of the valve apparatus, a control apparatus and/or at least one sensor and/or an input apparatus and/or a safety switch. The method includes operating the pneumatic system in a first operating mode in which the valve apparatus pneumatically actuates the pneumatic actuator, detecting a state and/or event, as a response to the detected state and/or event, bringing the pneumatic system from the first operating mode into a second operating mode in which the valve apparatus pneumatically actuates the pneumatic actuator in the second operating mode whilst taking into account at least one parameter, in a manner such that the pneumatic actuation in the second operating mode differs from the pneumatic actuation in the first operating mode due to taking the parameter into account.

### CROSS-REFERENCE TO RELATED APPLICATION

This application claims priority to German application 10 2024 117 373.4, filed Jun. 20, 2024, which is incorporated herein by reference.

### BACKGROUND OF THE INVENTION

The invention relates to a method for the operation of a pneumatic system for industrial automation, comprising at least one pneumatic function component which comprises a valve apparatus and at least one pneumatic actuator which can be pneumatically actuated by way of the valve apparatus, wherein the pneumatic system further comprises a control apparatus and/or at least one sensor and/or an input apparatus and/or a safety switch, wherein the method comprises the following steps: operating the pneumatic system in a first operating mode, in particular in a normal operating mode, in which the valve apparatus pneumatically actuates the pneumatic actuator, detecting a state and/or event.

### SUMMARY OF THE INVENTION

An object of the invention lies in providing a high efficiency of the system whilst ensuring the safety of the pneumatic system.

This object is achieved by a method according to claim 1. The method further comprises the step, as a response to the detected state and/or event, of bringing the pneumatic system from the first operating mode into a second operating mode, in particular into a safety mode, wherein the valve apparatus pneumatically actuates the pneumatic actuator in the second operating mode whilst taking into account at least one parameter, in a manner such that the pneumatic actuation in the second operating mode differs from the pneumatic actuation in the first operating mode on account of taking the parameter into account, wherein the state and/or the event is detected on the basis of an input signal and/or with the control apparatus and/or with the at least one pneumatic function component, wherein the input signal is a sensor signal which is detected by way of the sensor, an input signal which is generated by an input of a user into the input apparatus, a safety signal which is generated by the position of the safety switch and/or a signal which is generated by the at least one pneumatic function component.

The invention further relates to a pneumatic system for industrial automation, comprising at least one pneumatic function component which comprises a valve apparatus and at least one pneumatic actuator which can be pneumatically actuated by way of the valve apparatus, wherein the pneumatic system is configured to be operated in a first operating mode, in particular in a normal operating mode, in which the valve apparatus pneumatically actuates the pneumatic actuator, wherein the pneumatic system is further configured to detect a state and/or an event, wherein the pneumatic system is further configured to be brought from the first operating mode into a second operating mode, in particular into a safety mode, wherein the valve apparatus is configured to pneumatically actuate the pneumatic actuator in the second operating mode whilst taking into account at least one parameter, in a manner such that the pneumatic actuation in the second operating mode differs from the pneumatic actuation in the first operating mode on account of taking the parameter into account, wherein the pneumatic system further comprises a control apparatus and/or at least one sensor and/or an input apparatus and/or a safety switch, wherein the pneumatic system is further configured to detect the state and/or the event on the basis of an input signal and/or with the control apparatus and/or with the at least one pneumatic function component, wherein the input signal is a sensor signal which is detected by way of the sensor, an input signal which is generated by an input of a user into the input apparatus, a safety signal which is generated by a position of the safety switch and/or a signal which is generated by the at least one pneumatic function component.

### BRIEF DESCRIPTION OF THE DRAWINGS

Further exemplary details as well as exemplary embodiments are hereinafter explained with reference to the figures. Herein are shown:

FIG. 1 a pneumatic system,

FIG. 2 a further pneumatic system with an input apparatus,

FIG. 3 a further pneumatic system with a first pneumatic function component and with a second pneumatic function component, and

FIG. 4 a method for the operation of a pneumatic system.

### DETAILED DESCRIPTION

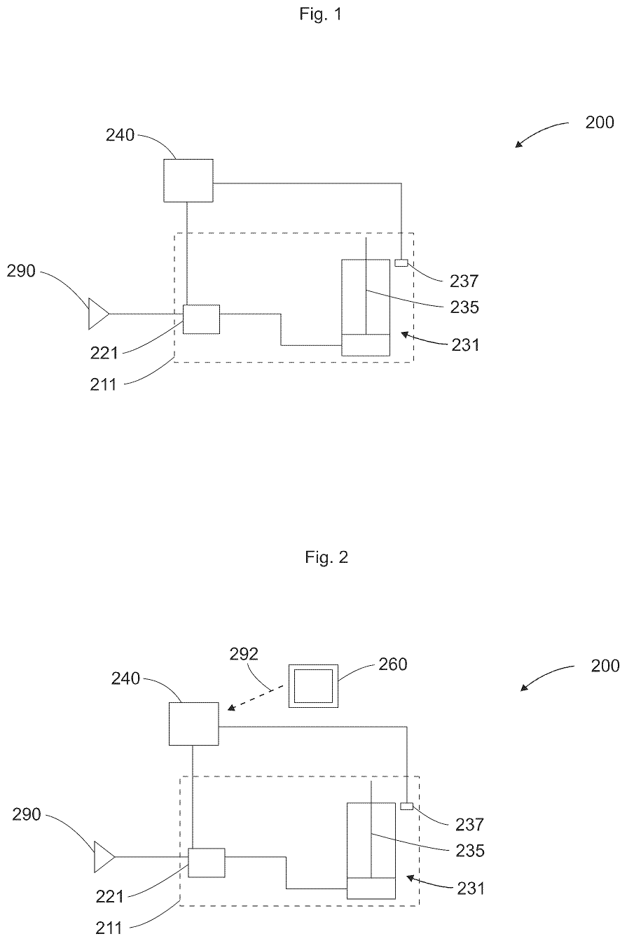

FIG. 1 shows a pneumatic system 200 in a schematic representation. The pneumatic system 200 comprises a first pneumatic function component 211. The first pneumatic function component 211 comprise a first valve apparatus 221 and a first pneumatic actuator 231 which can be pneumatically actuated by way of the first valve apparatus 221.

Preferably, the valve apparatus 221 comprises at least one proportional valve, in particular several proportional valves. Further preferably, the proportional valves are each arranged in a valve cartridge, wherein the valve apparatus 221 comprises several valve cartridges. Such a valve apparatus 221 with several valve cartridges is also denoted as a valve terminal. Several valve cartridges can be grouped together into a so-called valve module. In particular, a valve module comprises four or five valve cartridges. The valve terminal can comprise several valve modules. Particularly preferably, each valve cartridge comprises two proportional valves, of which one is assigned each to a pneumatic supply and another each to a pneumatic exhaust. In particular, the proportional valves are designed as piezo-valves, i.e. the proportional valves each comprise a valve element which is designed as a piezo-bender or is coupled to a piezo-bender.

Preferably, the first pneumatic actuator 231 comprises an actuator element 235. By way of example, the first pneumatic actuator 231 is designed as a pneumatic cylinder. Furthermore, by way of example the actuator element 235 is designed as a piston with a piston rod. Alternatively or supplementarily, the first pneumatic actuator 231 can be designed as a gripper, as a pivot drive or as a cylinder without a piston rod.

By way of example, the pneumatic actuator 231 is a single-acting cylinder with a restoring element, for example restoring spring, or a dual-acting cylinder.

Preferably, the pneumatic function component 211 comprises at least one sensor which is designed as a position sensor 237 and with which the position of the actuator element 235 can be detected. The position sensor 237 purely by way of example is designed as an end position sensor. Alternatively, the position sensor 237 can be designed as a continuous path measurement system. In this manner, one can detect the position in which the actuator element 235 is located, in particular in the cylinder: A further position sensor 237 is preferably provided and this purely by way of example is likewise designed as an end position sensor. For example, a position sensor 237 which is designed as a lower end position sensor and a position sensor 237 which is designed as an upper position sensor are provided.

The pneumatic function component 211 preferably comprises at least one sensor which is designed as a pressure sensor. Further preferably, the pressure sensor is assigned to a pneumatic connection between the valve apparatus 221 and the first pneumatic actuator 231. Particularly preferably, at least one pressure sensor is assigned to each valve cartridge. The at least one pressure sensor can be arranged on the first pneumatic actuator 231. Alternatively or supplementarily, the at least one pressure sensor can be arranged in the valve apparatus 221.

The pressure sensor can be designed as a relative pressure sensor, by which means the pressure can be measured independently of a changing ambient pressure. Alternatively or supplementarily, an ambient pressure sensor can be additionally provided, in order to compute a relative pressure. Preferably, the at least one pressure sensor is designed as a temperature-compensated pressure sensor. Alternatively or supplementarily, a temperature sensor can be additionally provided, in order to compensate the temperature influence with regard to measuring technology.

If the first pneumatic actuator 231 is designed as a single-acting cylinder, in particular a pressure sensor is provided, said pressure sensor being assigned to a pressure chamber of the single-acting cylinder. If the first pneumatic actuator 231 is designed as a dual-acting cylinder, in particular two pressure sensors are provided, of which one is assigned to a first pressure chamber of the dual-acting cylinder and another to a second pressure chamber of the dual-acting cylinder.

The pneumatic system 200 preferably comprises a control apparatus 240. The control apparatus 240 is preferably coupled to the first valve apparatus 221 and to the position sensor 237 or to the position sensors 237. The first control apparatus 221 is preferably designed as a pressure regulating valve apparatus, so that for example a pressure which is applied to a pressure chamber of the pneumatic cylinder or a pressure which is applied each to one of two pressure chambers of the pneumatic cylinder can be closed-loop controlled. Alternatively or supplementarily, the first valve apparatus 221 is designed as a flow regulating valve apparatus, so that for example a flow of pressurised air which is to be achieved with respect to a pressure chamber of the pneumatic cylinder can be closed-loop controlled. In particular, the pressure is measured with the at least one pressure sensor for the purpose of the closed-loop control of the pressure and/or for the purpose of the closed-loop control of the throughflow.

The valve apparatus 221 preferably comprises an internal control and/or regulating appliance, which is designed for example as a controller. Furthermore, the internal control and/or regulating appliance are configured to control and/or closed-loop control the operation of the first pneumatic actuator 231. The internal control and/or regulating appliance is configured to communicate with the control apparatus 240 and/or an industrial PC, in particular in order retrieve a parameter which is to be taken into account on operation of the first pneumatic actuator 231, from the control apparatus 240 and/or from the industrial PC or to receive it from this control apparatus/industrial PC.

Preferably, the communication between the internal control and/or regulating appliance and the control apparatus 240 and/or the industrial PC is effected via a bus interface and/or a point-to-point connection, in particular via an IO link. Further preferably, the communication between the internal control and/or regulating appliance and the control apparatus 240 and/or the industrial PC is effected by wire and/or in a wireless manner.

The closed-loop control of the pressure and/or the closed-loop control of the flow are preferably effected by way of the control apparatus 240 and/or the internal control and/or regulating appliance.

The closed-loop control of the pressure is preferably effected with respect to the position. Herein, the at least one position sensor 237 detects the position of the actuator element 235. Furthermore, it is preferably examined by the control apparatus 240 and/or the internal control and/or regulating appliance as to whether the actuator element 235 is situated in a desired position which is to be set. If the actuator element 235 has not yet reached this desired position, then the first pneumatic actuator 231 is pneumatically actuated with the first valve apparatus 221. If the actuator element 235 reaches the desired position, then the position sensor 237 sends a corresponding signal to the control apparatus 240. The control apparatus 240 and/or the internal control and/or regulating appliance thereupon control the first valve apparatus 221 in a manner such that the actuator element 235 carries out no further movement. In the case of a pneumatic cylinder, this can be effected by way of the pressure being held in the pressure chamber or in the pressure chambers. Alternatively, after the actuator element 235 has reached the desired position, the control apparatus 240 and/or the internal control and/or regulating appliance controls the first valve apparatus 221 in a manner such that the actuator element 235 executes a movement which is opposite to the previous movement, in particular towards the further position sensor 237. The operation of the pneumatic system 200 which is described above is denoted as operation in one operating mode.

Alternatively or supplementarily, the control apparatus 240 and/or the internal control and/or regulating appliance are configured to carry out a closed-loop control of the position with respect to the actuator element 235. Preferably, this closed-loop control of the position relates to pressure, wherein signals of the at least one pressure sensor are used. The implementation of the position closed-loop control function and the pressure closed-loop control function can be effected in the same component of the pneumatic system 200, for example in the control apparatus 140 or in the internal control and/or regulating appliance. Alternatively, the implementation of the position closed-loop control function and of the pressure closed-loop control function can be effected in different components of the pneumatic system 200, for example the implementation of the position closed-loop control function in the control apparatus and the pressure closed-loop control function in the control and/or regulating appliance or vice versa.

The pneumatic system 200 is configured to be operated in a first operating mode and in a second operating mode.

Preferably, the pneumatic system 200 is configured to be operated in a regular operating mode concerning which no error function of the pneumatic system 200 is present. A regular operating mode for example is a normal operating mode. The pneumatic system 200 is further preferably configured to be operated in an irregular operating mode, concerning which an error function of the pneumatic system 200 is taken into account and an operation of the pneumatic system is rendered possible despite this. An irregular operating mode for example is a safety mode.

Ambient conditions which are of relevance to the operation can change during the operation of the pneumatic system 200, in particular during the previously outlined closed-loop control of the pressure. For example, it can be necessary for the actuator element 235 to be moved more quickly into the desired position, in order to accelerate a process. Alternatively, it can be necessary to save energy, for which the pressurised air consumption can be reduced and the actuator element would displace more slowly. Moreover, it can be necessary for the magnitude of characteristics of the actuator element 235 which relate to movement to be reduced, in particular in order to fulfil increased safety demands. Characteristics of the actuator element 235 which relate to movement are for example its speed and its momentum. The change of the ambient conditions which are relevant to the operation is detected as a respective event. The changed ambient conditions which are relevant to the operation are detected as a respective state.

For example, the entrance of a person into a safety region can be detected as an event and/or the presence of the person in the safety region as a respective state. As a response to the detected state and/or event, the pneumatic system 200 is brought from the first operating mode into a second operating mode, in particular a safety mode. The detected state and/or event are taken into account in the second operating mode. Herewith, the first valve apparatus 221 pneumatically actuates the first pneumatic actuator 231 whilst taking into account at least one parameter, in a manner such that the pneumatic actuation in the second operating mode differs from the pneumatic actuation in the first operating mode due to taking the parameter into account.

More than two operating modes can be provided, for example three, four, five or up to ten or up to twenty operating modes, depending on the demands and/or the ambient conditions which can change. Further possible operating modes are for example a rapid mode in which the process time is reduced, or an energy saving mode in which the necessary process energy is reduced. As described above, the first pneumatic actuator 231 can be operated in manner in which it is closed-loop controlled in pressure or flow. Preferably, one further envisages being able to change between an operation which is closed-loop controlled in pressure and one which is closed-loop controlled in flow. The change been the operating which is closed-loop controlled in pressure and the one closed-loop controlled in flow can be effected within one operating mode, for example within the first operating mode, and/or on bringing the pneumatic system 200 from one operating mode into another operating mode, for example on bringing the pneumatic system 200 from the first operating mode into the second operating mode.

Herein, a parameter can be a value of an operating parameter as well as an operating parameter with at least one associated value. Preferably, several parameters are provided. Further preferably, several parameters are grouped together into parameters sets, wherein each parameter set comprises at least one parameter.

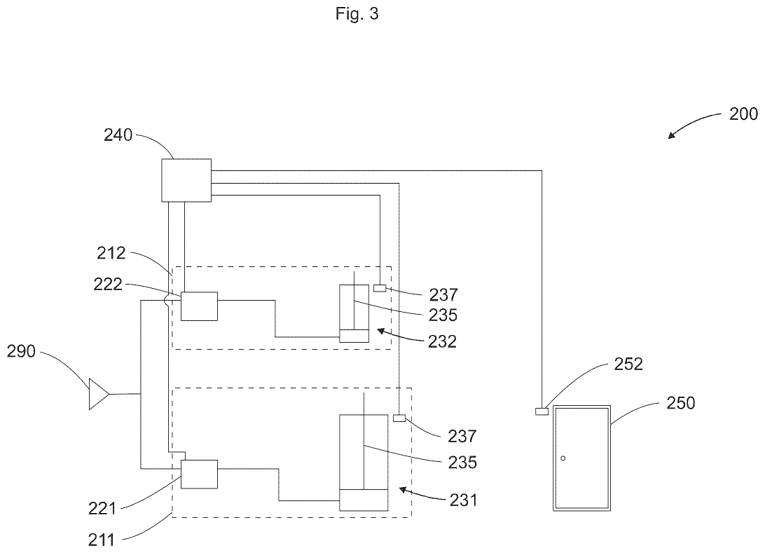

Preferably, the parameter and/or the parameter set or the parameter and/or the parameters sets are stored on the control apparatus. Alternatively, the parameter and/or the parameter set or the parameters and/or the parameter sets are stored on the first pneumatic function component 211. If several pneumatic function components are provided (cf. hereinafter concerning FIG. 3), preferably all parameters and/or parameter sets are stored in each case in the pneumatic function components which are assigned to them.

Furthermore, the first pneumatic function component 211 is preferably controlled by the control apparatus 240, at least by way of a control signal being made available to the first pneumatic function component 211 by way of the control apparatus 240, on the basis of which signal the parameter is retrieved.

Preferably, the state and/or the event is detected with the first pneumatic function component 211.

The parameters can be made available to the first pneumatic function component 211 in a direct manner and are therefore valid as specific to the components. The parameter can furthermore be made available to the complete pneumatic system 200 and is thus valid as specific to the system.

The parameter is a parameter which relates to the movement of the first pneumatic actuator 231 and for example can be a maximal pressure, a maximal displacement path, an end position, a maximal speed or a maximal force or be designed to change these attributes. Accordingly, the movement behaviour of the first pneumatic actuator 231 or the pneumatic system 200 is influenced or changed by taking the parameter into account.

Preferably, what is meant by a parameter in the context of the invention is not a setpoint for the closed-loop control, in particular for a closed-loop control of the pressure with the first valve apparatus 2211, but rather, the parameter influences this setpoint.

The parameter is preferably a limitation parameter which limits the pneumatic actuation of the pneumatic actuator 231 and/or a movement of an actuator element 235 of the pneumatic actuator 231.

Preferably, the state and/or the event are detected by the control apparatus. Further preferably, the first pneumatic function component 211 is controlled by the control apparatus 240 at least by way of the at least one parameter being made available to the first pneumatic function component 211 by the control apparatus 211.

The first pneumatic actuator 231 can be designed in a different size. By way of example, the limitation parameter is selected in a manner corresponding to the size of the first pneumatic actuator 231. The limitation parameter can be a maximal or minimal pressure for the pneumatic actuation. A minimal pressure is herein a pressure at which the pneumatic actuation of the first pneumatic actuator 231 is maximally limited without-whilst taking into account different external influences, such as for example the temperature—the pneumatic actuator 231 being put out of function. In contrast, the first pneumatic actuator 231 remains functionally ready given the application of the minimum pressure, wherein characteristics which relate to the movement, for example speeds and/or forces of the first pneumatic actuator 231 are reduced.

Herein, a maximal pressure is a pressure at which the pneumatic actuation of the first pneumatic actuator 231 is minimally limited, in particular is not limited, particularly preferably amplified by way of an amplification parameter without-whilst taking into account different external influences, such as for example the temperature-a risk of the first pneumatic actuator 231 being damaged on account of the pneumatic actuation, such a risk not longer being able to be dealt with.

In particular, differently dimensioned pneumatic actuators are provided, wherein the minimal pressure for the lesser-dimensioned actuator, in particular the first pneumatic actuator is not sufficient in order to bring the more largely dimensioned pneumatic actuator, in particular a second pneumatic actuator 232 (cf. FIG. 3), into a function state.

Preferably, the taking into account of the at least one parameter in the safety mode leads to at least one variable which is related to movement having a lower value than this at least one movement-related variable in the normal operating mode. In particular, the pressure which is assigned to the pneumatic actuator is lower in the safety mode than in the normal operating mode. Further preferably, entailed by this, the speed of the pneumatic actuator and/or the force which is exerted by the pneumatic actuator is lower in the safety mode than in the normal operating mode.

Further preferably, a third operating mode which is designed as a rapid mode is provided and/or alternatively the second operating mode is designed as a rapid mode. In particular, the taking into account of the at least one parameter in the rapid mode leads to at least one movement-related variable having a larger value that this at least one movement-related variable in normal operating mode. In particular, the pressure which is assigned to the pneumatic actuator is greater in the rapid mode than in the normal operating mode. Further preferably, entailed by this, the speed of the pneumatic actuator and/or the force which is exerted by the pneumatic actuator is larger in the rapid mode than in the normal operating mode.

The pneumatic system 200 which is represented in FIG. 2 is based on the pneumatic system 200 which is represented in FIG. 1, wherein with regard to the pneumatic system 200 which is represented in FIG. 2, an input apparatus 260 is further provided. Preferably, the input apparatus 260 is configured to transmit an input signal 292 to the control apparatus 240. Alternatively, the input apparatus 260 is configured to transmit the input signal 292 directly to the first valve apparatus 221. A respective state and/or event are detected on detection of the input signal. Preferably, the input apparatus 260 is configured to give a user a selection of operating modes. Further preferably, the input apparatus 260 is configured to permit the user the selection of an operating mode to be set. If the user selects an operating mode, in particular the second operating mode, the input apparatus 260 transmits a respective input signal 292 to the pneumatic system 200, whereupon a state and/or event are detected by this in a corresponding manner. As described beforehand, as a response to the detected state and/or event, the pneumatic system 200 is brought from the first operating mode into the second operating mode.

The state and/or event is preferably detected on the basis of an input signal 292, wherein the input signal 292 is a sensor signal which is detected by way of a sensor which is assigned to the pneumatic system 200 (cf. hereinafter concerning FIG. 3), an input signal which is generated by an input of a user into an input apparatus 260 which is assigned to the pneumatic system 200, a safety signal which is generated by a position of a safety switch which is assigned to the pneumatic system 200 and/or a signal which is created by the pneumatic function component.

FIG. 3 shows a pneumatic system 200 with a first pneumatic function component 211 and with a second pneumatic function component 212. The pneumatic system 200 which is represented in FIG. 3 is based on the pneumatic system 200 which is represented in FIG. 3, wherein the pneumatic system 200 which is represented in FIG. 3, apart from the first pneumatic function component 211 which the pneumatic system 200 which is represented in FIG. 1 also comprises, additionally comprises a second pneumatic function component 212. Preferably, the first pneumatic function component 211 and the second pneumatic function component 212 at all events are designed equally from a functional point of view. Inasmuch as this is concerned, that which has been explained with regard to the first pneumatic function component 211 also applies to the second function component 212.

By way of example, the second pneumatic function component 212 comprises a second valve apparatus 222 which is the same as the first valve apparatus 211, a position sensor 237 and a second pneumatic actuator 232 which at least functionally is the same as the first pneumatic actuator 231. Preferably, the second pneumatic actuator 232 is designed smaller than the first pneumatic actuator 231. Herein, what is to be understood as a smaller pneumatic actuator is a pneumatic actuator for whose operation a lower pressure is to be applied in the pressure chamber that for a larger pneumatic actuator. For this, in particular one envisages the pressure chamber of the smaller pneumatic actuator having a lower base surface than the pressure chamber of the larger pneumatic actuator.

Preferably, the control apparatus 240 is coupled to the second valve apparatus 222 and/or to the position sensor 237 which is assigned to the second pneumatic actuator 232.

Preferably, the pneumatic system 200 further comprises a safety door 250 and a sensor which is assigned to the safety door 250 and is designed as a safety sensor 252. By way of example, the safety door 250 is configured to shield the remaining pneumatic system 200, in particular the first pneumatic actuator 231 and the second pneumatic actuator 232. For this, by way of example, a safety fence which can be passed through a safety door 250 is additionally provided. In particular, the safety sensor 252 is configured to detect a position of the safety door 250. By way of example, the safety sensor 252 is configured to detect when the safety door 250 is opened and/or is open. The safety sensor 252 is preferably coupled to the control apparatus 240.

Preferably, the pneumatic system 200 which is represented in FIG. 3 is operated in the first operating mode. In the first operating mode, a pneumatic actuation of the first pneumatic actuator 232 by the first valve apparatus 221 and a pneumatic actuation of the second pneumatic actuator 232 by the second valve apparatus 222. Further preferably, the first pneumatic actuator 231 and the second pneumatic actuator 232 are operated at the same pressure, by way of example at 6 bar.

If the safety door 250 is opened and/or the safety door 250 is open, the safety sensor 252 detects this event and/or state and sends a respective signal to the control apparatus 240. As a response to the detected state and/or event, the pneumatic system 200 is then brought from the first operating mode into a second operating mode, in particular a safety mode. For this, a parameter is made available to the first valve apparatus 221 and/or the second valve apparatus 240, in particular by the control apparatus 240. This parameter leads and/or these parameters lead to the pneumatic actuation of the first pneumatic actuator 231 and/or of the second pneumatic actuator 232 in the second operating mode differing from the pneumatic actuation in the first operating mode on account of taking the parameter or parameters into account. Herein, at least two of the parameters differ from one another.

Preferably, the taking into account of at least one parameter leads to the pressure which is applied in the pressure chamber of the first pneumatic actuator 231 and/or the pressure which is applied in the pressure chamber of the second pneumatic actuator 232 differing from the pressure which is applied in a corresponding manner during the first operating mode. In particular, in the second operating mode, the pressure which is assigned to the first pneumatic actuator 231 is greater than the pressure which is assigned to the second pneumatic actuator 232. Further preferably, in the second operating mode the pressure which is assigned to the first pneumatic actuator 231 and the pressure which is assigned to the second pneumatic actuator 232, are each sufficient to still only just permit a pneumatic actuation of the first pneumatic actuator 231 and/or of the second pneumatic actuator 232. In particular, in the second operating mode the pressure which is assigned to the second pneumatic actuator 232 is not sufficient in order to pneumatically actuate the first pneumatic actuator 231. By way of example, in the second operating mode the pressure which is assigned to the first pneumatic actuator 231 is greater than the pressure assigned to the second pneumatic actuator 232. Furthermore, by way of example, in the second operating mode the pressure which is assigned to the first pneumatic actuator 231 is 4 bar, whereas the pressure which is assigned to the second pneumatic actuator is 3 bar.

The parameter which is taken into account in the first and/or second operating mode can be assigned to a single pneumatic function component, i.e. for example to the first pneumatic function component 211 and/or to the second pneumatic function component 212. Such an operating mode is denoted as a component mode. Herewith, it is only the first valve apparatus 221 or the second valve apparatus 222 of the first pneumatic function component 211 or of the second pneumatic function component 212, to which the component mode is assigned, which pneumatically actuates the first pneumatic actuator 231 or the second pneumatic actuator 232 whilst taking onto account a respective parameter which is assigned to the component mode.

Alternatively or supplementarily, the parameter which is taken into account in the first and/or the second operating mode can be assigned to several pneumatic function components, i.e. for example to the first pneumatic function component 211 and to the second pneumatic function component 212. The first operating mode is then denoted as a system mode which is assigned to the pneumatic system 200 and in which each valve apparatus 221 and/or 222 pneumatically actuates the respective pneumatic actuator 231 and/or 232 whilst taking into account a respective parameter which is assigned to the system mode.

Further preferably, the parameter is assigned to an operating mode. In particular, a parameter set is assigned to each operating mode, for example a parameter set which leads to an increase of movement-related variables of the first pneumatic actuator 231 and/or of the second pneumatic actuator 232 and which is assigned to the rapid mode, and a parameter set which leads to a reduction of movement-related variables of the first pneumatic actuator 231 and/or of the second pneumatic actuator 232 and is assigned to a safety mode and/or energy saving mode and/or slow mode.

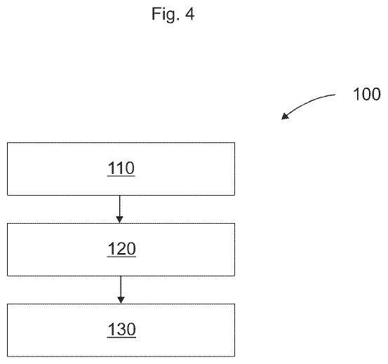

FIG. 4 shows a method 100 for the operation of a pneumatic system 200, in particular to one of the pneumatic systems 200 which are represented in FIGS. 1 to 3.

In a first step 110, an operation of the pneumatic system 200 is effected in a first operating mode, in particular in a normal operating mode, in which the valve apparatus 221 and/or 222 actuates the pneumatic actuator 231 and/or 232. In a second step 120 which is subsequent to the first step 10, a detection of a state and/or event is effected. In a third step 130 which is subsequent to the second step 120, a bringing of the pneumatic system 200 from a first operating mode into a second operating mode, in particular into a safety mode is effected as a response to the detected state and/or event, wherein valve apparatus 221 and/or 222 pneumatically actuates the pneumatic actuator 231 and/or 232 in the second operating mode whilst taking into account at least one parameter, in a manner such that the pneumatic actuation in the second operating mode differs from the pneumatic actuation in the first operating mode due to the parameter being taken into account.

The preferred embodiments described above can be combined with each other in any manner without leaving the scope.

1. A method for operating a pneumatic system for industrial automation, comprising at least one pneumatic function component which comprises a valve apparatus and at least one pneumatic actuator which can be pneumatically actuated by way of the valve apparatus, wherein the pneumatic system further comprises a control apparatus and/or at least one sensor and/or an input apparatus and/or a safety switch, wherein the method comprises the following steps:
operating the pneumatic system in a first operating mode, in which the valve apparatus pneumatically actuates the pneumatic actuator,
detecting a state and/or event,
as a response to the detected state and/or event, bringing the pneumatic system from the first operating mode into a second operating mode, wherein the valve apparatus pneumatically actuates the pneumatic actuator in the second operating mode whilst taking into account at least one parameter, in a manner such that the pneumatic actuation in the second operating mode differs from the pneumatic actuation in the first operating mode due to taking the parameter into account, wherein the state and/or event is detected on the basis of an input signal and/or with the control apparatus and/or with the at least one pneumatic function component, wherein the input signal is a sensor signal which is detected by way of the sensor, an input signal which is generated by an input of a user into the input apparatus, a safety signal which is generated by a position of the safety switch and/or a signal which is generated by the at least one pneumatic function component.

2. The method according to claim 1, wherein the parameter is a limitation parameter which limits the pneumatic actuation of the pneumatic actuator and/or a movement of an actuation element of the pneumatic actuator.

3. The method according to claim 2, wherein the limitation parameter is a maximal pressure for the pneumatic actuation.

4. The method according to claim 1, wherein the pneumatic system comprises a plurality of pneumatic function components which each comprise a respective valve apparatus and at least one respective pneumatic actuator which can be pneumatically actuated by way of the respective valve apparatus, wherein in the first operating mode each valve apparatus pneumatically actuates the respective pneumatic actuator, and wherein in the second operating mode each valve apparatus pneumatically actuates the respective pneumatic actuator whilst taking a respective parameter into account, in a manner such that the pneumatic actuations in the second operating mode differ from the pneumatic actuations in the first operating mode due to taking the parameter into account.

5. The method according to claim 4, wherein the first operating mode is designed as a system mode which is assigned to the pneumatic system and in which each valve apparatus pneumatically actuates the respective pneumatic actuator whilst taking into account a respective parameter which is assigned to the system mode, or as a component mode which is assigned to at least one pneumatic function component and in which only the valve apparatuses of the at least one pneumatic function component to which the component mode is assigned actuate the respective pneumatic actuator whilst taking into account a respective parameter which is assigned to the component mode, and/or the second operating mode is designed as a system mode or as a component mode.

6. The method according to claim 1, wherein the pneumatic system comprises a control apparatus, wherein the at least one parameter is stored in the control apparatus.

7. The method according to claim 1, wherein the at least one parameter is stored in the at least one pneumatic function component.

8. The method according to claim 1, wherein the first operating mode is a normal operating mode, and wherein the second operating mode is a safety mode.

9. The method according to claim 4, wherein at least two of the parameters differ from one another.

10. A pneumatic system for industrial automation, comprising at least one pneumatic function component, a valve apparatus and at least one pneumatic actuator which can be pneumatically actuated by way of the valve apparatus, wherein the pneumatic system is configured to be operated in a first operating mode, in which the valve apparatus pneumatically actuates the pneumatic actuator, wherein the pneumatic system is further configured to detect a state and/or an event, wherein the pneumatic system is further configured to be brought from the first operating mode into a second operating mode, wherein the valve apparatus is configured to pneumatically actuate the pneumatic actuator in the second operating mode whilst taking into account at least one parameter, in a manner such that the pneumatic actuation in the second operating mode differs from the pneumatic actuation in the first operating mode due to taking the parameter into account, wherein the pneumatic system further comprises a control apparatus and/or at least one sensor and/or an input apparatus and/or a safety switch, wherein the pneumatic system is further configured to detect the state and/or the event on the basis of an input signal and/or with the control apparatus and/or with the at least one pneumatic function component, wherein the input signal is a sensor signal which is detected by way of the sensor, an input signal which is generated by an input of a user into the input apparatus, a safety signal which is generated by a position of the safety switch and/or a signal which is generated by the at least one pneumatic function component.

11. The pneumatic system according to claim 10, further comprising a control apparatus, wherein the at least one parameter is stored in the control apparatus.

12. The pneumatic system according to claim 10, wherein the at least one parameter is stored in the at least one pneumatic function component.

13. The pneumatic system according to claim 10, comprising a plurality of pneumatic function components which each comprise a respective valve apparatus and at least one respective pneumatic actuator which can be pneumatically actuated by way of the respective valve apparatus, wherein the pneumatic system is configured such that in the first operating mode each valve apparatus pneumatically actuates the respective pneumatic actuator, and wherein the pneumatic system is configured such that in the second operating mode each valve apparatus pneumatically actuates the respective pneumatic actuator whilst taking into account a respective parameter, in a manner such that the pneumatic actuations in the second operating mode differ from the pneumatic actuations in the first operating mode due to taking the parameter into account.

14. The pneumatic system according to claim 10, wherein the first operating mode is a normal operating mode, and wherein the second operating mode is a safety mode.

15. The pneumatic system according to claim 13, wherein at least two of the parameters differ from one another.
